(19) United States
(12) Patent Application Publication
(10) Pub. No.: US 2009/0023912 A1
(43) Pub. Date: Jan. 22, 2009

(54) Water-soluble, uv-absorbing and/or flourescent components with very high isoelectric points

(76) Inventors: Gyula Vigh, Magnolia, TX (US); Sanjiv K. Lalwani, College Station, TX (US); Brent Busby, Hillsboro, OR (US); Kingsley Nzeadibe, Bryan, TX (US); Helen C. Fleisher, College Station, TX (US); Evan E. Shave, Pacifica, CA (US)

Correspondence Address: THORPE NORTH & WESTERN, LLP., P.O. Box 1219, SANDY, UT, 84091-1219, US

(21) Appl. No.: 11/587,080

(22) PCT Filed: Apr. 22, 2005
(86) PCT No.: PCT/US2005/014031

§ 371 Date: Feb. 25, 2008

Related U.S. Application Data
(60) Provisional application No. 60/564,480, filed on Apr. 22, 2004.

(51) Int. Cl. C08B 37/16

(52) U.S. Cl. 536/103

(57) ABSTRACT

Water-soluble, UV-absorbing and/or fluorescing compound having an isoelectric point greater than 10, can be obtained using molecules chosen from the group of molecules consisting of those containing at least one secondary alcohol OH group with a PKₐ value greater than 10 and at least one amino group with a pK_{b} value smaller than 5, those containing at least one primary alcohol OH group and at least one secondary alcohol OH group with respective PKₐ values greater than 10 and at least one amino group with a pK_{b} value smaller than 5 or a quaternary ammonium group, and those containing at least two secondary alcohol OH groups with respective pKₐ values greater than 10 and at least one amno group with a pK_{b} value smaller than 5 or a quaternary ammonium group; and having at least one UV absorbing group or at least one fluorescing group or a combination thereof. The invention includes methods for producing such compounds.

### BACKGROUND OF THE INVENTION

1. Field

The invention is in the field of isoelectric focusing and compounds having isoelectric points (pI values) that are used as markers during isoelectric focusing.

2. State of the Art

In isoelectric focusing, pI markers are needed to establish the course of the pH gradient in which the separation occurs. Proteins with well characterized pI values are frequently used as pI markers. However, proteins are hydrolytically and oxidatively unstable; degraded proteins have pI values that are different from those of the original proteins. Therefore, attempts have been made to use well focusing small molecules as pI markers, e.g., UV absorbing aminomethyl phenols and aminomethyl nitrophenols [Slais, K., Friedl, Z., J. Chromatogr. A 661 (1994) 249-256; Slais, Z. Friedl, J. Chromatogr. A 695 (1995) 113-122]; fluorescein derivatives [Horka M, Willimann T, Blum M, Nording P, Friedl Z, Slais K., J. Chromatogr. A 916 (2001) 65-71; Slais K, Horka M, Novackova J, Friedl Z., Electrophoresis, 23 (2002) 1682-1688] and fluorescent tag-labeled tri- and tetrapeptides [Shimura K, Kamiya K, Matsumoto H, Kasai K, Anal. Chem. 74 (2002) 1046-1053]. A small molecule is considered a well focusing marker when the absolute value of the difference between its pI value and its pKₐ value closest to the pI value is less than 1. Unfortunately, these small molecule pI markers are available only in a limited pI range, typically from 3<pI<10.5, and often have poor aqueous solubilities which limit their applications.

For accurate characterization of very basic proteins, it would be desirable to have UV absorbing or fluorescing, water soluble pI markers for the 10.5<pI range as well. Unfortunately, such pI markers are not available due to the pKₐ limitation of amines.

### SUMMARY OF THE INVENTION

According to the invention, water-soluble, UV-absorbing and/or fluorescing compound having an isoelectric point greater than 10, can be obtained using molecules chosen from the group of molecules consisting of those containing at least one secondary alcohol OH group with a pKₐ value greater than 10 and at least one amino group with a pK_{b} value smaller than 5, those containing at least one primary alcohol OH group and at least one secondary alcohol OH group with respective pKₐ values greater than 10 and at least one amino group with a pK_{b} value smaller than 5 or a quaternary ammonium group, and those containing at least two secondary alcohol OH groups with respective pKₐ values greater than 10 and at least one amino group with a pK_{b} value smaller than 5 or a quaternary ammonium group; and having at least one UV absorbing group or at least one fluorescing group or a combination thereof.

We have found that the pKₐ values of the secondary alcohol groups of certain carbohydrates and polyhydroxy compounds lie in the 10.5<pKₐ<13.5 range, while the pKₐ values of the primary alcohol groups are typically in the pKₐ>13.5 range. For example, the pKₐ values for the secondary alcohol OH group of the native cyclodextrins are as follows: α-CD: 12.05; β-CD: 12.20; γ-CD: 12.33. The pKa values for the secondary alcohol OH group of a few simple carbohydrates are as follows: maltose: 11.94; mannose: 12.08; glucose: 12.28; dulcitol: 13.43; sorbitol: 13.60.

By creating a molecule that contains at least one such secondary alcohol OH group with a 10.5<pKₐ<13.5 and an amine group with a 1<pK_{b}<4 or at least two such secondary alcohol OH groups with pKₐ values in the 10.5<pKₐ<13.5 range and one strong electrolyte cationic group (such as a quaternary ammonium group) or at least one such secondary alcohol OH group with a pKₐ value in the 10.5<pKₐ<13.5 range and one such primary alcohol OH group with a pKₐ value in the 13<pKₐ range and one strong electrolyte cationic functional group (such as a quaternary ammonium group), an isoelectric substance with a high pI value can be formed. If a UV absorbing or fluorescing functional group is attached to such an isoelectric substance such that the material remains soluble in water, small molecule pI markers for the 10<pI range are created.

We have also found that the secondary alcohols of many oligo- and polysaccharides including, but not restricted to, cyclodextrins, maltodextrins, amyloses, starches, celluloses, guar gums, etc., have the same desired property (alcoholic OH groups with pKa values in the 10.5<pKₐ<13.5 range) and these oligomers and/or polymers can be modified with suitable amine or quaternary ammonium functional groups to create high pI isoelectric materials which can be converted into UV absorbing or fluorescing, water soluble pI markers with 10<pI values.

Furthermore, we have found that the secondary alcohol groups of many oligomeric and polymeric materials including, but not restricted to, poly(vinyl alcohol) and its derivatives, partially or fully hydrolyzed poly(epihalohydrine)s and their derivatives, polymers formed from mono-, di-, oligo- or polyepoxides also have the same desired properties (alcoholic OH groups with pKₐ values in the 10.5<pKₐ<13.5 range) and these oligomers and/or polymers can be modified with suitable amine or quaternary ammonium functional groups to create high pI isoelectric materials that subsequently can be converted into UV absorbing or fluorescing, water soluble pI markers with 10<pI values.

Apart from serving as pI markers, many additional tasks can be solved utilizing the UV-absorbing and/or fluorescing compounds that have very high isoelectric points (pI values) and high aqueous solubilities without departing from the essence of this disclosure. For example, they can also be used as cathodic blocking agents in both imaging and single-point detection capillary isoelectric focusing systems as described in copending U.S. application Ser. No. 10/763,981, incorporated herein by reference.

The invention also includes the method of making a water-soluble, UV-absorbing and/or fluorescing compound having an isoelectric point greater than 10, by obtaining molecules chosen from the group of molecules consisting of those containing at least one secondary alcohol OH group with a pKₐ value greater than 10, those containing at least one primary alcohol OH group and at least one secondary alcohol OH group with respective pKₐ values greater than 10, and those containing at least two secondary alcohol OH groups with respective pKₐ values greater than 10; attaching to such molecules at least one amino group having a pK_{b} value smaller than 5 selected from the group consisting of primary amino, secondary amino, tertiary amino and quaternary ammonio groups; and attaching at least one UV absorbing group or at least one fluorescing group or a combination thereof.

An alternate method comprises obtaining molecules chosen from the group of molecules consisting of those containing at least one secondary alcohol OH group with a pKₐ value greater than 10 and at least one amino group with a pK_{b} value smaller than 5, those containing at least one primary alcohol OH group and at least one secondary alcohol OH group with respective pKₐ values greater than 10 and at least one amino group with a pK_{b} value smaller than 5 or a quaternary ammonium group, and those containing at least two secondary alcohol OH groups with respective pKₐ values greater than 10 and at least one amino group with a pK_{b} value smaller than 5 or a quaternary ammonio group; and attaching to such molecules at least one UV absorbing group or at least one fluorescing group or a combination thereof.

A further alternate method of making a water-soluble, UV-absorbing and/or fluorescing compound having an isoelectric point greater than 10, comprises obtaining molecules chosen from the group of molecules consisting of those containing at least a UV absorbing group or a fluorescing group or a combination thereof, and at least one secondary alcohol OH group with a pKₐ value greater than 10 or at least one primary alcohol OH group and at least one secondary alcohol OH group with respective pKₐ values greater than 10 or at least two secondary alcohol OH groups with respective pKₐ values greater than 10; and attaching to such molecules at least one amino group having a pK_{b} value smaller than 5 selected from the group consisting of primary amino, secondary amino, tertiary amino or quaternary ammonio groups or combinations thereof.

A still further alternate method of making a water-soluble, UV-absorbing and/or fluorescing compound having an isoelectric point greater than 10, comprises obtaining molecules chosen from the group of molecules consisting of those containing at least a UV absorbing group or a fluorescing group or a combination thereof, and at least one amino group having a pK_{b} value smaller than 5 selected from the group consisting of primary amino, secondary amino, tertiary amino or quaternary ammonio groups or combinations thereof, and attaching at least one R group wherein R contains at least one secondary alcohol OH group with a pKₐ value greater than 10 or at least one primary alcohol OH group and at least one secondary alcohol OH group with respective pKₐ values greater than 10 or at least two secondary alcohol OH groups with respective pKₐ values greater than 10 or combinations thereof.

### THE DRAWING

In the accompanying drawing:

FIG. 1 is a graph showing an overlay of two runs of a three band PreMCE (pressure-mediated capillary electrophoretic) experiment using mono(6-deoxy-6-pyridinium) -β-cyclodextrin (CDP) p-toluenesulfonate salt showing cationic and anionic migration.

### DETAILED DESCRIPTION OF EXAMPLES OF THE INVENTION

1. Synthesis of mono(6-deoxy-6-pyridinium)-β-cyclodextrin (CDP) p-toluenesulfonate salt

Mono(6-deoxy-6-pyridinium)-β-cyclodextrin p-toluenesulfonate salt, CDP, was synthesized from mono-6-O-tosyl β-CD and pyridine. Mono-6-O-tosyl-β-CD was obtained by adding 11.5 g (10 mmol) β-CD, 4.9 g (15 mmol) tosyl anhydride and 250 mL deionized water to a 0.5 L round bottom flask. After stirring at ambient temperature for 2 hours, 5 g NaOH in 50 mL deionized water was added and the unreacted tosyl anhydride was filtered off after 10 min, followed by the addition of 13.4 g of NH₄Cl to precipitate mono-6-O-tosyl-β-CD that was washed with water and acetone. The purity of the product was>98% mol/mol (HPLC analysis with a 250 mm long, 4.6 mm I.D. column packed with 5 μm Luna silica, Phenomenex, Torrence, Calif., USA, 70:30 ethylacetate: methanol as eluent and a flow rate of 2.0 mL/min).

250 mL dry pyridine was added to a 0.5 L three neck round bottom flask, purged with N₂, followed by the addition of 10 g mono-6-O-tosyl-β-CD. The reaction mixture was heated to 70° C. and stirred in a N₂ atmosphere for 48 hrs. Excess pyridine was evaporated, the residue was dissolved in 60 mL deionized water, the undissolved solids were filtered off, about ⅔ of water was evaporated and the remaining solution was dropped into 250 mL acetone. A precipitate formed that was filtered off, redissolved in water and reprecipitated with acetone. Dissolution and reprecipitation was repeated three times, the product was dried in a vacuum oven at ambient temperature and analyzed by capillary electrophoresis (CE), high resolution MALDI-TOF-MS and ¹H NMR.

Pressure-mediated capillary electrophoretic (PreMCE) analysis [Williams, B. A., Vigh, Gy., Anal. Chem., 68 (1996) 1174-1180] using background electrolytes (BGEs) that contained sodium carbonate and sodium hydroxide indicated that the pI value of CDP was in the 12<pI<12.3 range (vide infra).

The approximate pI values of ampholytes can be calculated from their effective electrophoretic mobilities measured at different pH values in the 11<pH<13.5 range. In a 3-band PreMCE experiment, a band of analyte A is injected for tᵢₙⱼ (1 second) by low pressure on the P/ACE 5000 instrument (Beckman-Coulter, Fullerton, Calif.). Next, pure BGE is injected for a period of t_{transf} (30 seconds) by the same low pressure to move analyte A into the capillary for distance l_{transf} (first transfer step). Next, neutral marker N1 is injected for tᵢₙⱼ (first neutral marker band, N1), then transferred into the capillary by pure BGE for l_{transf}. Another band of neutral marker (second neutral marker band, N2) is injected for time tᵢₙⱼ and transferred into the capillary by pure BGE for l_{transf} resulting in bands of A, N1 and N2 that are equidistant (l_{transf}) from each other in the capillary. Next, the band train is electrophoresed for t_{migr} at potential Uₐₚₚₗ, with the anode at the injection end and the cathode at the detector end of the capillary, followed by the injection of a third neutral marker band (push peak, P). Then, the entire band train is mobilized through the detector window by low pressure and the detector trace is recorded.

The mobilization velocity, V_{mob} can be calculated from the injector-to-detector distance, L_{d} and the mobilization time of the push peak, tₚ. From v_{mob} and the time difference between the mobilization times of N2 and N1, (t_{N2}-t_{N1}), one can calculate the transfer distance, l_{transf}. From v_{mob} and the time difference between the mobilization times of P and N2, (t_{P}-t_{N2}) one can calculate the sum of l_{transf} and the distance migrated by electroosmosis, l_{BO}. Finally, from v_{mob} and the time difference between the mobilization times of N1 and A, (t_{N1}-t_{A}), one can calculate the sum of l_{transf} and the effective electrophoretic migration distance of A, l^{eff} _{A}. From l^{eff} _{A}, t_{migr} and the field strength, E (E=Uₐₚₚₗ/Lₜ), one can calculate the effective electrophoretic mobility of the analyte, μ^{eff} _{A}. A positive sign for μ^{eff} _{A} means that the band of A migrates cationically, a negative sign means that the band of A migrates anionically. The pH range over which the sign of μ^{eff} _{A} changes brackets the pI value of analyte A.

The PreMCE technology can also be used to visually locate the pI range of analyte A. To do so, a 3-band PreMCE experiment is completed at a selected pH for the band sequence A, N1, N2. The detector trace of the run is displayed twice in the data analysis software: the second copy of the detector trace is shifted to align the peak centroid of N2 in the second copy of the trace with the peak centroid of N1 in the first copy of the same trace causing the peak centroid of N1 in the second copy of the trace to indicate the position, in the first copy of the trace, where the band of A was before electrophoresis (because l_{transf} is the same for A and N1, and N1 and N2). When peak A in the first copy of the trace lies to the left of peak N1 in the second copy of the trace, the band of A migrated cationically. If it lies to the right, it migrated anionically.

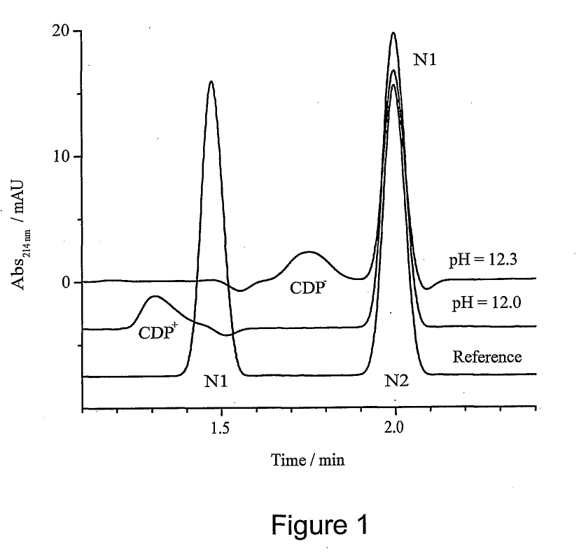

Using the 1-(3-sulfopropyl)pyridinium hydroxide, inner salt, as a neutral marker (N1, N2 and P), three band PreMCE experiments were carried out with CDP in BGEs whose pH was increased in approximately 0.2-0.3 units between pH=11 and pH=13.5. For the experiments with CDP, tᵢₙⱼ=1 s, t_{transf}=30 s, t_{migr}=4 min and Uₐₚₚₗ=15 kV were used. The runs were evaluated as described and the results from two experiments in which cationic and anionic migration was observed, were overlaid in FIG. 1. FIG. 1 indicates that 12.0<pI_{CDP}<12.3.

2. Synthesis of mono(6-deoxy-6-N,N-dimethylbenzylammonio)-β-cyclodextrin p-toluenesulfonate salt (CDMB)

Mono(6-deoxy-6-N,N-dimethylbenzylammonio)-β-cyclodextrin p-toluenesulfonate salt, CDMB, was synthesized using the procedure described in Example 1 above, except that N,N-dimethylbenzylamine was used as UV absorbing amine. The identity and purity of the product was established by CE, high resolution MALDI-TOF-MS and ¹H NMR.

PreMCE analysis using background electrolytes that contained sodium carbonate and sodium hydroxide as described in Example 1 above indicated that the pI value of CDMB was in the 12<pI<12.5 range.

3. Synthesis of mono(6-deoxy-6-(N,N,N′-trimethyl-N-3-propoxy-phenyl)ammonio)-β-cyclodextrin salt (CDMPA)

Mono(6-deoxy-6-(N,N,N′-trimethyl-N-3-propoxy-phenyl)diammonio)-β-cyclodextrin salt, CDMPA, was synthesized using the procedure described in Example 1, except that mono-6-O-tosyl-β-CD was first coupled with N,N,N′-trimethylamine in excess N,N,N′-trimethylamine as solvent. The resulting tertiary diamine was converted into the mono-quatemary ammonium derivative by the UV absorbing chromophore, 3-phenoxypropyl bromide, and the di-quaternary ammonium derivative by methyl iodide in DMF. The identity and purity of the product was established by CE, high resolution MALDI-TOF-MS, and ¹H and ¹³C NMR.

PreMCE analysis using background electrolytes that contained sodium carbonate and sodium hydroxide as described above in Example 1 indicated that the pI value of CDMPA was in the 11<pI<13 range.

4. Synthesis of N,N-dimethyl-N-(3-phenoxypropyl)-D-glucaminium bromide (DMPG)

N,N-dimethyl-N-(3-phenoxypropyl)-D-glucaminium bromide, DMPG was obtained from N,N-dimethyl-D-glucamine and 3-phenoxypropyl bromide. N,N-dimethyl-D-glucamine was synthesized by carefully adding 6.79 g (128 mmol) aqueous formic acid (88 % v/v) and 4.57 g (56.3 mmol) aqueous formaldehyde (37% v/v) into an iced-down 0.5 L round bottom flask that had an attached Liebig condenser. After addition, the solution was brought to ambient temperature. 10.0 g (51.2 mmol) of N-methyl-D-glucamine was added to the reaction mixture in portions, and was then refluxed and stirred. After 16 hrs and cooling to ambient temperature, 5.3 g concentrated HCl was added drop-wise to the flask and water was removed by azeotrope vacuum distillation. The product was recrystallized from ethanol and vacuum dried to obtain N,N-dimethyl-D-glucamine, HCl salt. 30 mL anhydrous MeOH was cooled and 1.17 g (50.9 mmol) freshly cleaned sodium metal was carefully dissolved in it. 10.6 g of N,N-dimethyl-D-glucamine, HCl salt, was slurried in 50 mL hot methanol, added to the methanolic sodium methoxide solution and refluxed for 20 min. NaCl was filtered off and methanol was removed under reduced pressure. The identity and purity of the intermediate was established by CE, high resolution MALDI-TOF-MS, and ¹H and ¹³C NMR.

50 mL of isopropanol was added to a 0.5 L three-neck round bottom flask, 5.0 g (23.9-mmol) N,N-dimethyl-D-glucamine was dissolved in it. 0.625 g (30 mmol) 3-phenoxypropyl bromide dissolved in 50 mL acetonitrile was added to it drop-wise and refluxed for 52-hrs. Then, the solvent was removed in vacuum, the oily residue was washed with acetonitrile and acetone, then chilled in a dry ice/acetone bath under reduced pressure yielding 5.2 g (51% m/m yield) white solid.

The reaction was monitored by indirect-UV detection CE using a 30 mM β-alanine BGE titrated to pH 3.6 with p-toluenesulfonic acid. The identity and purity of the final product was established by CE, high resolution MALDI-TOF-MS, and ¹H and ¹³C NMR.

PreMCE analysis using background electrolytes that contained sodium carbonate and sodium hydroxide as described above indicated that the pI value of DMPG was in the 13.1<pI<13.5 range.

The water soluble, UV-absorbing pI markers of the invention with high pI values allow extension of the calibration range of the pH gradient in isoelectric focusing to values higher than pH 10. The markers can also be used as cathodic blockers for imaging isoelectric focusing separations as described in copending U.S. application Ser. No. 10/763,981. According to the method of that that application, the concentration detection limit in capillary isoelectric focusing (CIEF) and imaging capillary isoelectric focusing (iCIEF) systems is improved when the sample holding volume of the isoelectric focusing system is increased by adding an auxiliary compartment to at least one end, and preferably both ends, of the separation capillary, especially when the use of an added auxiliary compartment is combined with the addition of at least one auxiliary agent. The auxiliary agent is added so that during isoelectric focusing the auxiliary agent substantially forces the ampholytic sample components from the auxiliary compartment into the separation capillary where detection takes place. This increases the concentration of the ampholytic sample components in the separation capillary, thereby improving the concentration detection limit in the capillary isoelectric focusing system. Adding an auxiliary agent without an auxiliary compartment will also work to improve the concentration detection limit, although not as effectively. The preferred auxiliary agents are ampholytic compounds. When the auxiliary agent is an ampholytic compound, it should have an isoelectric point either lower than or higher than the isoelectric points of all of the ampholytic components of interest in the sample. The pI markers of this invention with high pI values are perfect for use as the auxiliary agents having an isoelectric point higher than the isoelectric points of all of the ampholytic components of interest in the sample.

Numerous other UV-absorbing or fluorescent, water soluble pI markers that have high pI values could be made along the synthetic lines described above, and these could be just as useful as the examples described here.

Whereas the invention is here illustrated and described with reference to embodiments thereof presently contemplated as the best mode of carrying out the invention in actual practice, it is to be understood that various changes may be made in adapting the invention to different embodiments without departing from the broader inventive concepts disclosed herein and comprehended by the claims that follow.

1. A water-soluble, UV-absorbing and/or fluorescing compound having an isoelectric point greater than 10, comprising:
molecules:
chosen from the group of molecules consisting of those containing at least one secondary alcohol OH group with a pKₐ value greater than 10 and at least one amino group with a pK_{b} value smaller than 5, those containing at least one primary alcohol OH group and at least one secondary alcohol OH group with respective pKₐ values greater than 10 and at least one amino group with a pK_{b} value smaller than 5 or a quaternary ammonium group, and those containing at least two secondary alcohol OH groups with respective pKₐ values greater than 10 and at least one amino group with a pK_{b} value smaller than 5 or a quaternary ammonium group; and
having at least one UV absorbing group or at least one fluorescing group or a combination thereof.

2. A water-soluble, UV-absorbing and/or fluorescing compound according to claim 1, wherein the molecule is selected from a group consisting of alcohols, diols, triols, tetraols and polyols.

3. A water-soluble, UV-absorbing and/or fluorescing compound according to claim 1, wherein the molecule is a carbohydrate derivative.

4. A water-soluble, UV-absorbing and/or fluorescing compound according to claim 1, wherein the molecule is a cyclodextrin derivative.

5. A water-soluble, UV-absorbing and/or fluorescing compound according to claim 1, wherein the molecule contains at least one primary amino or secondary amino or tertiary amino or quaternary ammonio group or combinations thereof.

6. A water-soluble, UV-absorbing and/or fluorescing compound according to claim 1, wherein the molecule contains at least one UV absorbing and/or fluorescing aryl, alkylaryl, alkoxyaryl or heteroaromatic functional group or combinations thereof.

7. A water-soluble, UV-absorbing and/or fluorescing compound according to claim 1, wherein the at least one UV absorbing and/or fluorescing group in the molecule is selected from the group containing phenyl, alkylphenyl, alkoxyphenyl, hydroxyphenyl, alkyl(hydroxyphenyl), alkoxy(hydroxyphenyl), phenoxy, alkoxyphenoxy, hydroxyphenoxy, alkoxy(hydroxyphenoxy), naphthyl, alkylnaphthyl, alkoxynaphthyl, hydroxynaphthyl, alkyl(hydroxynaphthyl), alkoxy(hydroxynaphthyl), naphthoxy, alkoxynaphthoxy, hydroxynaphthoxy, alkoxy(hydroxynaphthoxy), pyridinium, alkylpyridinium, alkoxypyridinium, hydroxypyridinium, alkyl(hydroxypyridinium), alkoxy(hydroxypyridinium), pyridiniumoxy, (alkylpyridinium)oxy, (alkoxypyridinium)oxy, (hydroxypyridinium)oxy, (alkyl(hydroxypyridinium))oxy and (alkoxy(hydroxypyridinium))oxy groups.

8. A method of making a water-soluble, UV-absorbing and/or fluorescing compound having an isoelectric point greater than 10, comprising:
obtaining molecules:
chosen from the group of molecules consisting of those containing at least one secondary alcohol OH group with a pKa value greater than 10, those containing at least one primary alcohol OH group and at least one secondary alcohol OH group with respective pKₐ values greater than 10, and those containing at least two secondary alcohol OH groups with respective pKₐ values greater than 10;
attaching at least one amino group having a pK_{b} value smaller than 5 selected from the group consisting of primary amino, secondary amino, tertiary amino and quaternary ammonio groups; and
attaching at least one UV absorbing group or at least one fluorescing group or a combination thereof.

9. A method of making a water-soluble, UV-absorbing and/or fluorescing compound having an isoelectric point greater than 10, comprising:
obtaining molecules:
chosen from the group of molecules consisting of those containing at least one secondary alcohol OH group with a pKa value greater than 10 and at least one amino group with a pKb value smaller than 5, those containing at least one primary alcohol OH group and at least one secondary alcohol OH group with respective pKa values greater than 10 and at least one amino group with a pKb value smaller than 5 or a quaternary ammonium group, and those containing at least two secondary alcohol OH groups with respective pKa values greater than 10 and at least one amino group with a pKb value smaller than 5 or a quaternary ammonio group; and
attaching at least one UV absorbing group or at least one fluorescing group or a combination thereof.

10. A method of making a water-soluble, UV-absorbing and/or fluorescing compound having an isoelectric point greater than 10, comprising:
obtaining molecules:
chosen from the group of molecules consisting of those containing at least a UV absorbing group or a fluorescing group or a combination thereof, and at least one secondary alcohol OH group with a pKₐ value greater than 10 or at least one primary alcohol OH group and at least one secondary alcohol OH group with respective pKₐ values greater than 10 or at least two secondary alcohol OH groups with respective pKₐ values greater than 10; and
attaching at least one amino group having a pK_{b} value smaller than 5 selected from the group consisting of primary amino, secondary amino, tertiary amino or quaternary ammonio groups or combinations thereof.

11. A method of making a water-soluble, UV-absorbing and/or fluorescing compound having an isoelectric point greater than 10, comprising:
obtaining molecules:
chosen from the group of molecules consisting of those containing at least a UV absorbing group or a fluorescing group or a combination thereof, and at least one amino group having a pK_{b} value smaller than 5 selected from the group consisting of primary amino, secondary amino, tertiary amino or quaternary ammonio groups or combinations thereof; and
attaching at least one R group wherein R contains at least one secondary alcohol OH group with a pKₐ value greater than 10, or at least one primary alcohol OH group and at least one secondary alcohol OH group with respective pKₐ values greater than 10, or at least two secondary alcohol OH groups with respective pKₐ values greater than 10, or combinations thereof.
